(19) United States
(12) Patent Application Publication
(10) Pub. No.: US 2014/0174767 A1
(43) Pub. Date: Jun. 26, 2014

(54) Method for Controlling and/or Preventing a Fire in a Vehicle Air-Conditioning System

(71) Applicants: Thomas Woehrle, Stuttgart-Feuerbach (DE); Stephan Leuthner, Leonberg (DE); Rainer Kern, Stuttgart (DE)

(72) Inventors: Thomas Woehrle, Stuttgart-Feuerbach (DE); Stephan Leuthner, Leonberg (DE); Rainer Kern, Stuttgart (DE)

(73) Assignees: SAMSUNG SDI CO., LTD., Yongin-si, Gyeonggi-do (KR); ROBERT BOSCH GmbH, Stuttgart (DE)

(21) Appl. No.: 14/124,735

(22) PCT Filed: Jun. 4, 2012
(86) PCT No.: PCT/EP2012/060458

§ 371 Date: Mar. 13, 2014

(30) Foreign Application Priority Data
Jun. 9, 2011 (DE) 10 2011 077 312.6

(51) Int. Cl. A62C 3/07

(52) U.S. Cl. CPC A62C 3/07
USPC 169/45; 169/46; 169/43

(57) ABSTRACT

A method for controlling and/or preventing a fire in a vehicle air-conditioning system which contains 2,3,3,3-tetrafluoro-1-propene as a coolant includes bringing the components of the air-conditioning system containing the coolant into contact with an extinguishing agent which contains an aqueous solution or suspension of a compound containing calcium and a gelling extinguishing agent additive.

The present invention relates to a method for controlling and/or preventing a fire in a vehicle air-conditioning system.

### PRIOR ART

Most new vehicles now come equipped with an air-conditioning system, which frequently comprises a heat exchanger filled with a refrigerant. Because, however, traditional refrigerants are suspected of being climate damaging, concrete moves are afoot to introduce a Europe-wide standard for a new refrigerant for certain types of vehicle. 2,3,3,3-Tetrafluoro-1-propene (also known as R1234yf), the favored refrigerant in this connection, is significantly climate-friendlier, according to the manufacturer. However, one disadvantage of this refrigerant is the fact that R1234yf is flammable although not highly or extremely. And a fire, according to the manufacturer, can lead to the release of hydrogen fluoride (HF), an extremely toxic and highly corrosive compound.

Common extinguishants, such as water or carbon dioxide, are incapable of binding or neutralizing hydrogen fluoride.

DE 10 2009 035 908 A1 describes using an extinguishant for controlling and/or preventing a fire involving secondary lithium-ion batteries. The extinguishant contains a calcium compound and a gel-forming extinguishant additive.

### DISCLOSURE OF THE INVENTION

One or more of the prior art problems described can be overcome or at least ameliorated by means of the method according to the present invention. The method for controlling and/or preventing a fire in a vehicle air-conditioning system containing 2,3,3,3-tetrafluoro-1-propene as refrigerant, is characterized in that at least the constituents of the air-conditioning system (and any products formed therefrom in the event of a fire) which contain the refrigerant are brought into contact with an extinguishant which contains an aqueous solution or suspension of a calcium-containing compound and of a gel-forming extinguishant additive.

The invention rests on the realization that a combination of a calcium-containing additive (in the form of calcium ions) with a generally polymeric gel-forming agent is able to bind hydrogen fluoride forming in the event of a fire.

A weight fraction of gel-forming extinguishant additive per volume of extinguishant is preferably in the range from 0.1 to 3.0% w/v, especially in the range from 0.2 to 2.0% w/v and more preferably in the range from 0.1 to 1.0% w/v (weight per volume). The maximum weight fraction of the gel is intended to ensure that salting out of the calcium content by the gel is avoided. The presence of the gel as an additive in the extinguishant composition of the present invention has the advantage over purely water that a higher cooling performance is effectuated in principle by an appreciably reduced rate of evaporation on the part of the water. At the same time, the gel film on the burning matter ensures oxygen exclusion.

A weight fraction of calcium-containing compound per volume of extinguishant is further preferably in the range from 1% to 40% w/v, especially in the range from 10 to 30% w/v and more preferably equal to 20% w/v.

Any water-resistant calcium-containing compounds are in principle suitable for the method. However, it is particularly preferable for the calcium-containing compound to be an inorganic salt, such as calcium chloride (CaCl₂) in particular.

A further aspect of the invention relates to the use of the above-described extinguishant which contains an aqueous solution or suspension of a calcium-containing compound and of a gel-forming extinguishant additive, for controlling and/or preventing a fire in a vehicle air-conditioning system containing 2,3,3,3-tetrafluoro-1-propene as refrigerant.

The extinguishant can be used as mixed on the site of use or ready-mixed. Suitable dispensers and devices for gel delivery are well known from the prior art.

Water-absorbing polymers can be used as gel-forming agents. Examples include the Evonik product available under the trade name of Firesorb and the BASF product available under the trade name of Prevento.

### Operative Example

500 ml of 2,3,3,3-tetrafluoro-1-propene (HFO-1234yf from Honeywell) are ignited in a glass trough and subsequently extinguished with

a) purely water

b) a waterborne gelling solution of 10% calcium chloride (w/v) and 1% Prevento (w/v).

The fire did extinguish in comparative test a), but fluoride was detected in the fire-extinguishing water. When the inventive extinguishant as per test b) was used, the fire was put out more quickly and free fluoride could not be detected in the fire-extinguishing water. Hydrogen fluoride formed in the course of the fire became bound as a sparingly soluble precipitate in the form of calcium fluoride (CaF₂).

Firesorb gel-forming agent gave similar results.

1. A method for controlling and/or preventing a fire in a vehicle air-conditioning system containing 2,3,3,3-tetrafluoro-1-propene as a refrigerant, comprising:
bringing the constituents of the air-conditioning system which contain the refrigerant into contact with an extinguishant which contains an aqueous solution or suspension of a calcium-containing compound and of a gel-forming extinguishant additive.

2. The method as claimed in claim 1, wherein a weight fraction of the gel-forming extinguishant additive per volume of the extinguishant is in a range from 0.1 to 3.0% w/v.

3. The method as claimed in claim 2, wherein the weight fraction of the gel-forming extinguishant additive per volume of the extinguishant is in a range from 0.2 to 2.0% w/v.

4. The method as claimed in claim 1, wherein a weight fraction of the calcium-containing compound per volume of the extinguishant is in a range from 1% to 40% w/v.

5. The method as claimed in claim 1 wherein the calcium-containing compound is an inorganic salt.

6. The method as claimed in claim 5, wherein the calcium-containing compound is calcium chloride.

7. A method of using an extinguishant which contains an aqueous solution or suspension of a calcium-containing compound and of a gel-forming extinguishant additive, comprising:
controlling and/or preventing a fire in a vehicle air-conditioning system containing 2,3,3,3-tetrafluoro-1-propene as refrigerant using the aqueous solution or suspension of the calcium-containing compound and the gel-forming extinguishant additive.

8. The method as claimed in claim 7, wherein a weight fraction of the gel-forming extinguishant additive per volume of the extinguishant is in a range from 0.1 to 3.0% w/v.

9. The method as claimed in claim 7, wherein a weight fraction of the calcium-containing compound per volume of the extinguishant is in a range from 1% to 40% w/v.

10. The method as claimed in claim 7, wherein the calcium-containing compound is an inorganic salt.
